(19) United States
(12) Patent Application Publication
(10) Pub. No.: US 2025/0373279 A1
(43) Pub. Date: Dec. 4, 2025

(54) FRONT END ARCHITECTURE WITH CONVERGED 2G AND 5G BROADBAND

(71) Applicant: SKYWORKS SOLUTIONS, INC., Irvine, CA (US)

(72) Inventors: Kun Chen, Thousand Oaks, CA (US); Yu-Jui Lin, Westlake Village, CA (US); Sarah Shihui Xu, Thousand Oaks, CA (US); Zhu Liu, Camarillo, CA (US); Chun-Hua Yeh, Thousand Oaks, CA (US)

(21) Appl. No.: 19/220,204

(22) Filed: May 28, 2025

Related U.S. Application Data
(60) Provisional application No. 63/653,269, filed on May 30, 2024.

(51) Int. Cl. H04B 1/401; H04B 1/58

(52) U.S. Cl. CPC H04B 1/401; H04B 1/581

(57) ABSTRACT

A front end module configured to provide first and second signals conforming to different standards in similar frequency bands, the front end module including a first input; a second input; a first balun coupled to the first input and the second input; a second balun coupled to the first balun and configured to convert a double ended signal into a single ended signal; a filter section coupled to the second balun and configured to selectively filter one or more components of the single ended signal; and an output coupled to the filter section and configured to receive the single ended signal.

### CROSS-REFERENCE TO RELATED APPLICATIONS

This application claims priority under 35 U.S.C. § 119 (e) to U.S. Provisional Patent Application 63/653,269, titled FRONT END ARCHITECTURE WITH CONVERSED 2G AND 5G BROADBAND, filed on May 30, 2024, and hereby incorporated in its entirety for all purposes.

### BACKGROUND

### 1. Field of the Disclosure

At least one example in accordance with the present disclosure relates generally to transmission modules for 2G and 5G compatible telecommunication systems.

### 2. Discussion of Related Art

Telecommunication standards are evolving over time. Existing standards for cellular data transmission include 2G, which is being phased out, and 5G, which is being phased in. Old devices may transmit using the 2Gstandard, and new devices may transmit using the 5G standard, amongst others (e.g., 3G, 4G, etc.).

### SUMMARY

According to at least one aspect of the present disclosure, a front end module (FEM) is presented, the front end module configured to provide first and second signals conforming to different standards in similar frequency bands, the front end module including a first input; a second input; a first balun coupled to the first input and the second input; a second balun coupled to the first balun and configured to convert a double ended signal into a single ended signal; a filter section coupled to the second balun and configured to selectively filter one or more components of the single ended signal; and an output coupled to the filter section and configured to receive the single ended signal.

In some examples, the filter section includes a first node coupled to the second balun, and a second node coupled to the output, and further includes a parallel combination of a first switchable capacitor and a first inductor coupled between the first node and the second node, wherein the first switchable capacitor is configured to selectively couple or decouple from at least one of the first node or second node based on whether the front end module is providing a 2G or 5G signal. In some examples, the filter section further includes a low impedance switch coupled between the first node and a reference node, and a second switchable capacitor coupled between the first node and the reference node, wherein the low impedance switch is configured to selectively be open or closed based on whether the front end module is providing a 2G or 5G signal, and the second switchable capacitor is configured to selectively be coupled to the first node based on whether the front end module is providing a 2G or 5G signal.

In some examples, the filter section further includes a series combination of a capacitor and an inductor coupled between the low impedance switch and the reference node. In some examples, the filter section further includes a second inductor coupled between the second switchable capacitor and the reference node, and a capacitor coupled in parallel with the second switchable capacitor between the first node and the second inductor. In some examples, the parallel combination further includes second switchable capacitor. In some examples, the parallel combination further includes a second inductor. In some examples, the filter section further includes a series combination of the second inductor and a second switchable capacitor coupled between the first node and a reference node, wherein the second switchable capacitor is configured to selectively couple or decouple to the reference node based on whether the front end module is providing a 2G or 5G signal. In some examples, the filter section further includes a switch and an inductor coupled in series between the first node and the second node. In some examples, the FEM further comprises a first amplifier coupled between the first input and a first winding of the first balun and configured to provide an output signal to the first balun; and a capacitor coupled between the second input and a reference node.

In some examples, the FEM further comprises a first amplifier coupled to a first end of a second winding of the first balun and configured to provide a first output signal to a first end of a first winding of the second balun; a second amplifier coupled to a second end of the second winding of the first balun and configured to provide a second output signal to a second end of the first winding of the second balun. In some examples, the FEM further comprises a first capacitor coupled between the first end of the first winding of the second balun and a reference node; and a second capacitor coupled between the second end of the first winding of the second balun and the reference node. In some examples, the FEM further comprises a series combination of an inductor and a capacitor coupled between an output of the first amplifier and an output of the second amplifier. In some examples, the second balun includes a first winding and a second winding, the first winding having a tap located between a first end of the first winding and a second end of the first winding. In some examples, the FEM further comprises a first capacitor coupled to the tap and to a first inductor; a resistor coupled to the first inductor and a reference node; a second inductor coupled to the first tap; a second capacitor coupled to the second inductor and to a reference node; and a voltage node coupled between the second capacitor and the second inductor and configured to provide a voltage.

In some examples, the FEM further comprises one or more capacitors coupled between a second end of the second winding and a reference node, wherein the filter section is coupled to a first end of the second winding. In some examples, the FEM further comprises a first switch coupled to the filter section; and a second switch coupled to the first switch and to the output, wherein the first switch has one input and a plurality of outputs, and the second switch has one output and a plurality of inputs, wherein each output of the plurality of outputs is coupled via respective path to a respective input of the plurality of inputs. In some examples, one or more of the respective paths between the plurality of inputs and the plurality of outputs include a respective filter. In some examples, at least one respective path between the plurality of outputs and the plurality of inputs includes a capacitor coupled to a reference node.

In some examples, at least one respective path between the plurality of outputs and the plurality of inputs includes a series combination of a first capacitor and a parallel combination of a second capacitor and an inductor. In some examples, the FEM further comprises an output filter coupled between the second switch and the output, wherein the output filter includes a first node coupled to the output of the second switch, and a second node coupled to the output, a parallel combination of a switchable capacitor and an inductor coupled between the first node and the second node, the switchable capacitor being configured to selectively couple or decouple from one of the first node or second node based on whether the front end module is providing a 2G or a 5G signal. In some examples, the output filter further includes a series combination of a capacitor and an inductor coupled between the second node and a reference node.

In some examples, the second balun includes four or more layers, including a first layer, a second layer, a third layer, and a fourth layer, wherein the first layer is coupled to the third layer via a first connection and a second connection, and the second layer is coupled to the fourth layer via a third connection, wherein a tap of the balun is coupled to the third layer. In some examples, the first layer of the second balun includes a first section and a second section, the first section having a first input and the first connection, and the second section having a second input and the second connection. In some examples, an inductor is coupled to the tap and routed around the first input and the second input with at least one of odd symmetry or even symmetry. In some examples, the second layer includes a first output and the third connection, and the fourth layer includes a second output and the third connection.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a circuit topology according to an example;

FIG. 2A illustrates a circuit topology according to an example;

FIG. 2B illustrates a circuit topology according to an example;

FIG. 3 illustrates a circuit topology according to an example;

FIG. 4 illustrates a circuit topology according to an example;

FIG. 5A illustrates a circuit topology according to an example;

FIG. 5B illustrates a circuit topology according to an example;

FIG. 6 illustrates a circuit topology according to an example;

FIG. 7 illustrates a circuit topology according to an example;

FIG. 8 illustrates a circuit topology according to an example;

FIG. 9A illustrates a balun according to an example;

FIG. 9B illustrates a balun according to an example;

FIG. 10 illustrates a balun according to an example;

FIG. 11A illustrates a balun according to an example;

FIG. 11B illustrates a balun according to an example;

FIG. 12 illustrates a balun according to an example;

FIG. 13 illustrates a balun according to an example; and

FIG. 14 illustrates a balun according to an example.

### DETAILED DESCRIPTION

Telecommunications are steadily migrating toward the use of 5G (the fifth generation technology standard for cellular networks), and moving away from earlier generations such as 4G or 2G. However, a significant portion of the world still relies on 2G for their communications needs. In some estimations, even more than 80% of modern telecommunications rely on 2G. In some examples, the slowness of adopting 5G and moving away from 2G may be due to lack of 5G infrastructure, lack of cheap 5G devices, and so forth.

Aspects of the present disclosure relate to a front-end architecture (FEA) that supports both 2G and 5G efficiently using a power amplifier, or, additionally, any FEA that supports both an older standard (like 2G), and a newer standard (like 5G or 6G). Traditionally, FEAs and front-end modules (FEMs) have used separate systems for handling 2G and 5G signals. For example, a traditional system may have a chip dedicated to 5G signals and a chip dedicated to 2G signals, each chip having its own respective transmit (TX) and receive (RX) paths, its own voltage rails for supplying power, and even its own antenna for receiving and transmitting signals. This results in substantial excess materials being used in traditional designs (as the 2G and 5G architectures may both require their own power amplifiers, low noise amplifiers, filters, switches, and so forth). However, converged architectures (that support both 2G and 5G without using excess materials) face substantial implementation barriers. Among other things, 2G and 5G have significantly different power requirements, with 2G generally having higher power requirements than 5G. Furthermore, 2G and 5G have different linearity requirements as well, making designing output matching networks (OMNs) for 2G and 5G systems of all types difficult, especially if the OMNs must have wide frequency and power ranges. Additionally, power added efficiency (PAE) varies between 2G and 5G systems, and can make designing converged 2G and 5G architectures difficult as PAE may be poor for a converged system (or an unconverged system) in one mode (e.g., 5G mode), and good in the other mode (e.g., 2G mode). Poor PAE means the device housing the FEA may heat up substantially, posing a difficulty to handling and possibly damaging circuit components if the FEA overheats.

Aspects of this disclosure relate to a converged 2G and 5G FEA (and/or a converged FEA using any older and any newer standard) that addresses and mitigates the many problems identified above. In some examples, converged FEAs discussed herein use push-pull power amplifiers and OMNs to drive both 2G and 5G signals. In some examples, PAE is improved by 3-4% over traditional solutions, and the low-bandwidth modes for the FEA may have 32% fractional bandwidth (that is, the bandwidth of the FEA divided by its center frequency may correspond to 32%).

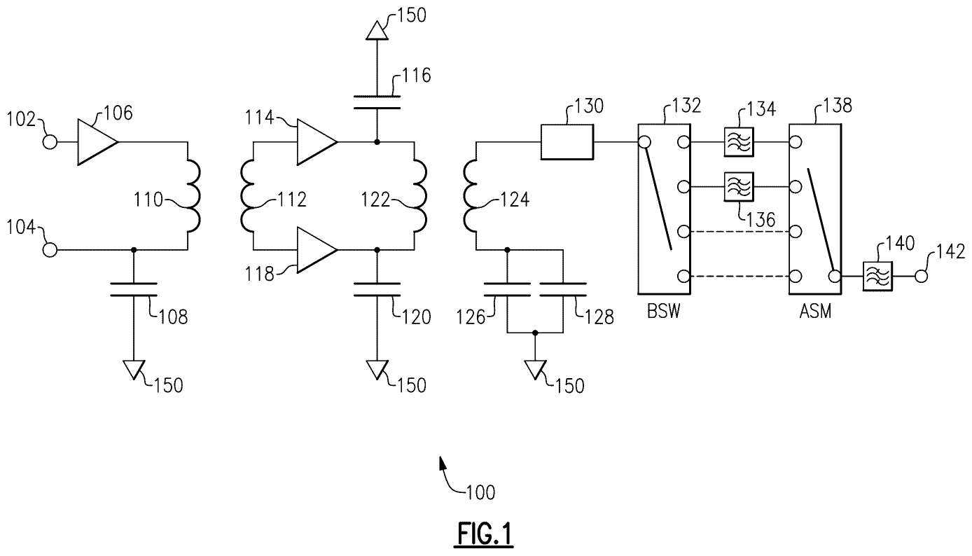

FIG. 1 illustrates a first topology 100 for an FEA. The first topology 100 includes a first input 102, a second input 104, a first amplifier 106, a first capacitor 108, a first winding 110, a second winding 112, a second amplifier 114, a second capacitor 116, a third amplifier 118, a third capacitor 120, a third winding 122, a fourth winding 124, a fourth capacitor 126, a fifth capacitor 128, a filter section 130, a band switch 132, a first filter 134, a second filter 136, an antenna switching module 138 (“ASM 138”), an antenna switching module filter 140 (“ASM filter 140”), an output 142, and a reference node 150.

The input 102 is coupled to an input of the first amplifier 106. An output of the first amplifier 106 is coupled to a first end of the first winding 110. A second end of the first winding 110 is coupled to the second input 104 and to a first end of the first capacitor 108. A second end of the first capacitor 108 is coupled to the reference node 150.

A first end of the second winding 112 is coupled to an input of the second amplifier 114, and a second end of the second winding 112 is coupled to an input of the third amplifier 118. An output of the first amplifier 114 is coupled to a first end of the second capacitor 116 and to a first end of the third winding 122. A second end of the second capacitor 116 is coupled to the reference node 150. An output of the third amplifier 118 is coupled to a second end of the third winding 122 and to a first end of the third capacitor 120. A second end of the third capacitor 120 is coupled to the reference node 150.

A first end of the fourth winding 124 is coupled to the filter section 130. A second end of the fourth winding 124 is coupled to a first end of the fourth capacitor 126 and a first end of the fifth capacitor 128. Respective second ends of the fourth and fifth capacitors 126, 128 are coupled to the reference node 150. The filter section 130 is further coupled to an input terminal of the band switch 132. Output terminals of the band switch 132 are coupled to respective conducting paths to respective input terminals of the ASM 138. In some examples, the conducting paths may have additional circuitry interposed between the output terminals of the band switch 132 and the input terminals of the ASM 138. In some examples, the first filter 134 is coupled between a first output terminal of the band switch 132 and a first input terminal of the ASM 138. In some examples, the second filter 136 is coupled between a second output terminal of the band switch 132 and the second input terminal of the ASM 138. An output terminal of the ASM 138 is coupled to the ASM filter 140. The ASM filter 140 is coupled to the output 142.

The first input 102 may be configured to receive an input signal, such as a voltage or current, and provide the input signal to the first amplifier 106. The input signal may vary with time. The first amplifier 106 may receive the input signal and amplify and/or attenuate the input signal or components (e.g., particular frequencies) of the input signal. The first amplifier 106 may provide the input signal to the first winding 110 (e.g., after altering the input signal).

The first winding 110 may be electromagnetically coupled to the second winding 112. For example, a current through the first winding 110 may induce a current through the second winding 112 according to the principals of magnetic induction. The input signal provided to the first winding 110 may therefore induce a second signal (e.g., a current) through the second winding 112. The first winding 110 may also provide the input signal, or another signal, to the first capacitor 108 and the second input 104. The first winding 110 may be an inductor, and may have the same number of turns, fewer turns, or more turns that the second winding 112. In some examples, the first winding 110 may be part of a balun. In some examples, the first winding 110 and second winding 112 may constitute a balun, for example, a single-to-double-ended balun.

The second input 104 may be coupled to a voltage or other circuit element. For example, the second input 104 may be configured to provide a low voltage or a high voltage. In some examples, the second input 104 provides a constant voltage, and in other examples, the second input 104 provides a time-varying voltage.

The first capacitor 108 may be configured to provide a signal to the reference node 150. The reference node 150 may be configured to provide a reference voltage (e.g., a voltage of zero or a voltage relative to which the other voltages in the first topology 100 are measured). In some examples, the reference node 150 may be configured to provide a lowest voltage in the first topology 100. The first capacitor 108 may be configured to route high frequency components of a given signal (such as the input signal or any signal induced on the first winding 110) to the reference node 150.

The second winding 112 may be an inductor and/or may be configured as a balun or part of a balun, for example, with the first winding 110. The second winding 112 may be configured to provide all and/or part of the second signal to the second amplifier 114 and/or third amplifier 118.

The second amplifier 114 may be configured to amplify and/or attenuate some or all of the portions of the second signal the second amplifier 114 receives from the second winding 112. The second amplifier 114 may be configured to provide the second signal (as altered) to the second capacitor 116 and/or the third winding 122.

The third amplifier 118 may be configured to amplify and/or attenuate some or all of the portions of the second signal the third amplifier 118 receives from the second winding 112. The third amplifier 118 may be configured to provide the second signal (as altered) to the third capacitor 120 and/or the third winding 122.

The second amplifier 114 and third amplifier 118 may be power amplifiers. The second and third amplifiers 114, 118 may be configured to operate as push-pull amplifiers. In some examples, the second and third amplifier 114, 118 may alternatively drive a signal. For example, the second amplifier 114 may provide an output based on the second signal to the second capacitor 116 and/or third winding 122 while the third amplifier 118 is not providing an output. Then, when the second amplifier 114 is no longer providing an output, the third amplifier 118 may provide an output to the third capacitor 120 and/or third winding 122.

The second capacitor 116 may be configured to block DC signals from the output node of the second amplifier 114 to the reference node 150. The third capacitor 120 may be configured to block DC signals from the output node of the third amplifier 118 to the reference node 150.

The third winding 122 may be electromagnetically coupled to the fourth winding 124. In some examples, the third winding 122 and fourth winding 124 may be configured to operate as a balun, for example, a double-to-single-ended balun. The third winding 122 may induce a third signal on the fourth winding 124.

The fourth winding 124 may provide the third signal to the fourth capacitor 126, fifth capacitor 128, and/or filter section 130.

The fourth capacitor 126 and second capacitor 128 may be configured to provide an improved Q-factor to the first topology 100, and may route portions of the third signal to the reference node 150. That is, the parallel combination of two smaller capacitors may provide a better Q factor than a single capacitor of equal capacitance.

The filter section 130 may filter the third signal in various ways. The function of the filter section 130 will be discussed in greater detail below. Once the filter section 130 has filtered the third signal, the filter section 130 may provide the third signal to the band switch 132.

The band switch 132 may have a single input terminal and numerous output terminals. The band switch 132 may be configured to couple the single input terminal to one or more of the numerous output terminals (but may, in some examples, couple the input terminal to only one output terminal at a time). The output terminal to which the input terminal is coupled may depend on the nature of the third signal and the desired qualities of the output signal.

The first filter 134 may be a filter, such as a bandpass, high pass, low pass, notch, or other type of filter. The first filter 134 may be a duplexer. The second filter 136 may be a filter, such as a bandpass, high pass, low pass, notch, or other type of filter. The second filter 136 may be a duplexer.

The ASM 138 may have numerous input terminals and a single output terminal. The ASM 138 may be configured to couple the single output terminal to one or more of the numerous input terminals (and may, in some examples, couple the output terminal to only one input terminal at a time). The input terminal to which the output terminal is coupled may depend on which respective output terminal of the band switch 132 is coupled to the input terminal of the band switch 132. The ASM 138 may route the third signal to the ASM filter 140.

The ASM filter 140 may be a filter, such as a bandpass, high pass, low pass, notch, or other type of filter. The ASM filter 140 may filter the third signal and provide an output signal, based on the third signal, to the output 142. The ASM filter 140 will be discussed in greater detail, below.

The output 142 may be coupled to an antenna and/or may be configured to provide a signal (such as a transmit signal) wirelessly or via a wired connection to other devices.

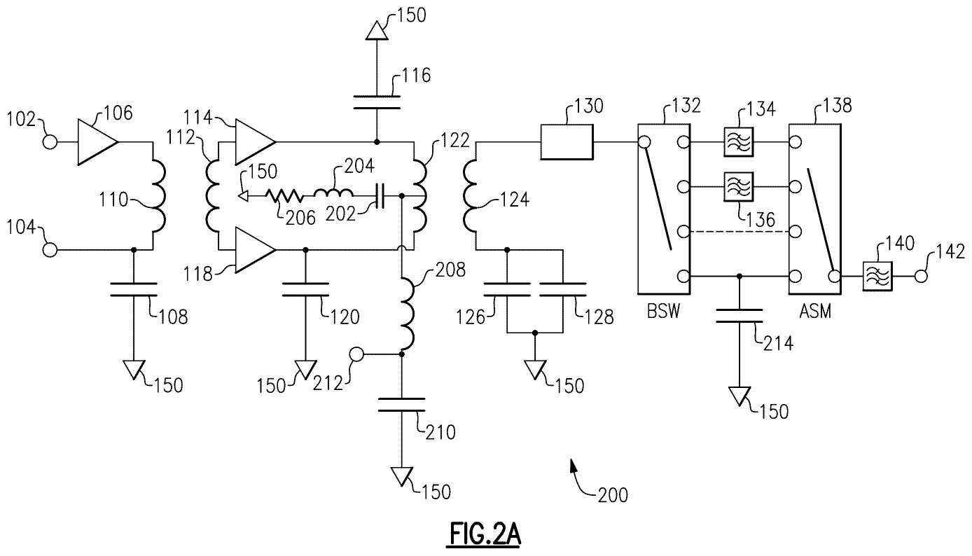

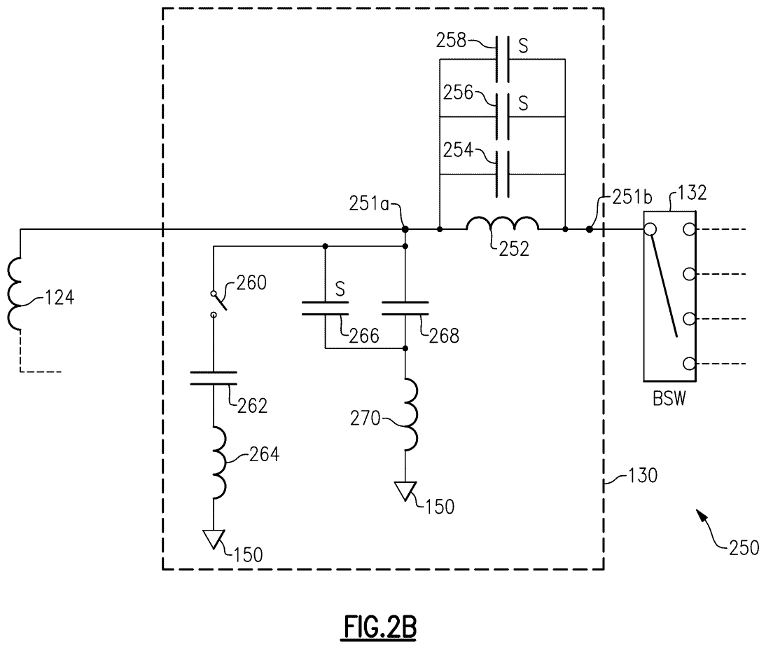

FIG. 2A illustrates a second topology 200 of a FEA according to an example. The second topology 200 is identical to the first topology 100 with a handful of exceptions. FIG. 2B illustrates one version of the filter section 130 which may be used with examples of topologies disclosed herein, including the second topology 200.

The second topology 200 includes the elements of the first topology 100 as well as a first tap capacitor 202, a first tap inductor 204, a first tap resistor 206, a second tap inductor 208, a second tap capacitor 210, a voltage node 212, and a conducting path capacitor 214.

The first tap capacitor 202 and second tap inductor 208 are coupled to a tap of the third winding 122. The tap of the third winding 122 may be located anywhere on the third winding 122, but, in some examples, may be a center tap located at or near the midpoint of the third inductor 122. The first tap inductor 204 is coupled to the first tap capacitor 202. The first tap resistor is coupled to the first tap inductor 204 and to the reference node 150. The second tap inductor 208 is coupled to the second tap capacitor 210 and to the voltage node 212. The second tap capacitor 210 is coupled to the reference node 150.

The voltage node 212 may be a low voltage node providing a voltage lower than the voltage of the reference node 150. The voltage node 212 may provide a voltage equal to or different from the voltage of the second input 104.

The tap capacitors 202, 210, tap inductors 204, 208, and tap resistor 206 may be used to tune the balun comprising the third winding 122 and fourth winding 124 and/or to provide harmonic impedance for said balun.

One of the conducting paths (for example, the nth and/or final conducting path) between the output terminals of the band switch 132 and the input terminals of the ASM 138 may be coupled to the conducting path capacitor 214. The conducting path capacitor 214 may be coupled to the reference node 150. The conducting path capacitor 214 may be configured to shunt certain frequencies of signals on the nth conducting path to the reference node 150. In some examples, the nth conducting path and/or the conducting path to which the conducting path capacitor 214 is coupled may be the conducting path corresponding to 2G transmissions.

FIG. 2B illustrates a subsection 250 of the second topology 200 including the filter section 130, according to an example. The version of the filter section 130 shown in the subsection 250 may be appropriate for use in the second topology 200 or in any other topology disclosed herein.

The filter section 130 includes a first inductor 252, a first capacitor 254, a first switchable capacitor 256, a second switchable capacitor 258, a switch 260, a second capacitor 262, a second inductor 264, a third switchable capacitor 266, a third capacitor 268, and a third inductor 270. Also shown are a first node 251a and a second node 251b. The fourth winding 124 and band switch 132 are shown to contextualize the coupling of internal components of the filter section 130 to the rest of the second topology 200 (or any other topology herein).

A respective first end of the first inductor 252, first capacitor 254, first switchable capacitor 256, and second switchable capacitor 258 are coupled to the first node 251a. A respective second end of the first inductor 252, first capacitor 254, first switchable capacitor 256, and second switchable capacitor 258 are coupled to the second node 251b. The first node 251a is coupled to the first end of the fourth winding 124. The second node 251b is coupled to the input terminal of the band switch 132.

Respective first ends of the switch 260, third switchable capacitor 266, and third capacitor 268 are coupled to the first node 251a. A second end of the switch 260 is coupled to the second capacitor 262. The second capacitor 262 is coupled to the second inductor 264. The second inductor 264 is coupled to the reference node 150. Respective second ends of the third capacitor 268 and third switchable capacitor 266 are coupled to the third inductor 270. The third inductor 270 is coupled to the reference node 150.

The switchable capacitors 256, 258, 266 may be switched on and/or off and may include a switch in series with the capacitor, for example. When on, the switchable capacitors 256, 258, 266 are part of the conducting paths from the first node 251a to the reference node 150 and/or from the first node 251a to the second node 251b. When off, the switchable capacitors 256, 258, 266 are not part of said conducting paths. For example, when the first and second switchable capacitors 256, 258 are on, they may be coupled in parallel with the first capacitor 254 and the first inductor 252 between the first node 251a and second node 251b. When the first and second switchable capacitors 256, 258 are off, they may be floating (e.g., not coupled to one or both of the first node 251a and/or second node 251b. Likewise, when the third switchable capacitor 266 is on, it may be coupled in parallel with the third capacitor 268 between the first node 251a and the third inductor 270. When the third switchable capacitor 266 is off, it may be floating (e.g., not coupled to one or both of the first node 251a and/or third inductor 268).

The switch 260 may be a low impedance switch (e.g., a switch having a low resistance). The switch 260 may be configured to selectively couple and/or decouple the second capacitor 262 from the first node 251a.

Referring now to a combination of FIGS. 2A and 2B, where the filter section 130 of the second topology 200 has the composition of the filter section 130 of FIG. 2B, said combination (which may be referred to as the second combination, for convenience, hereafter), may be configured to handle both 2G and 5G signals (e.g., transmitting 2G and 5G signals). However, depending on the band of the transmission (e.g., which band of frequencies incorporated into the 5G spectrum and/or 2G spectrum) or the mode of transmission (e.g., 2G or 5G), different switches may be closed (e.g., on) or open (e.g., off) and/or different switchable capacitors may be closed or open.

In some examples, the first switchable capacitor 256 may be off when transmitting 2G signals, and/or on when transmitting 5G signals (e.g., in the B12, B28, and/or B71 channels). In some examples, the second switchable capacitor 258 may be on when transmitting 2G signals and/or transmitting some 5G signals (e.g., on the B12 and/or B28 channels). In some examples, the third switchable capacitor 266 may be on when transmitting 2G signals and/or when transmitting 5G signals (e.g., on the B12, B28, and/or B71 bands). In some examples, the switch 260 may be closed when transmitting 2G signals, and open when transmitting 5G signals.

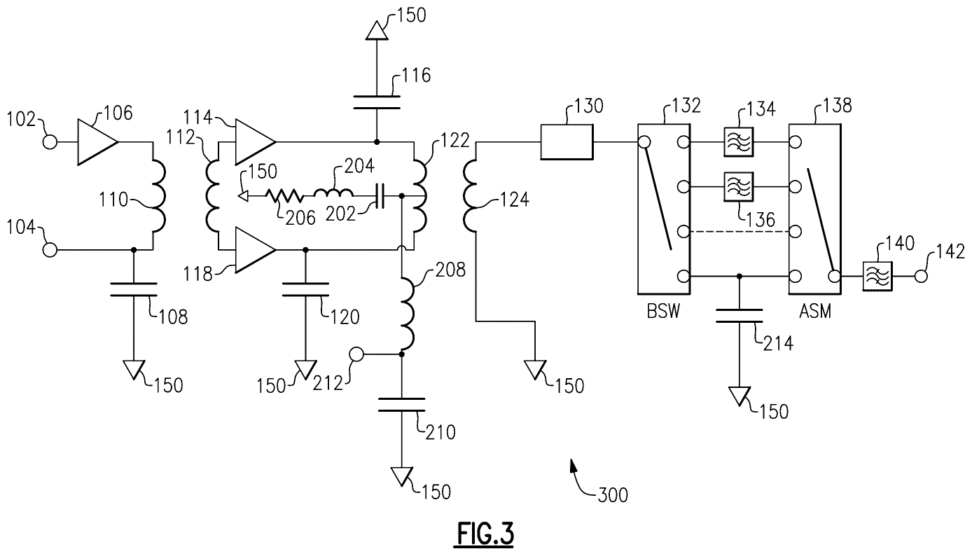

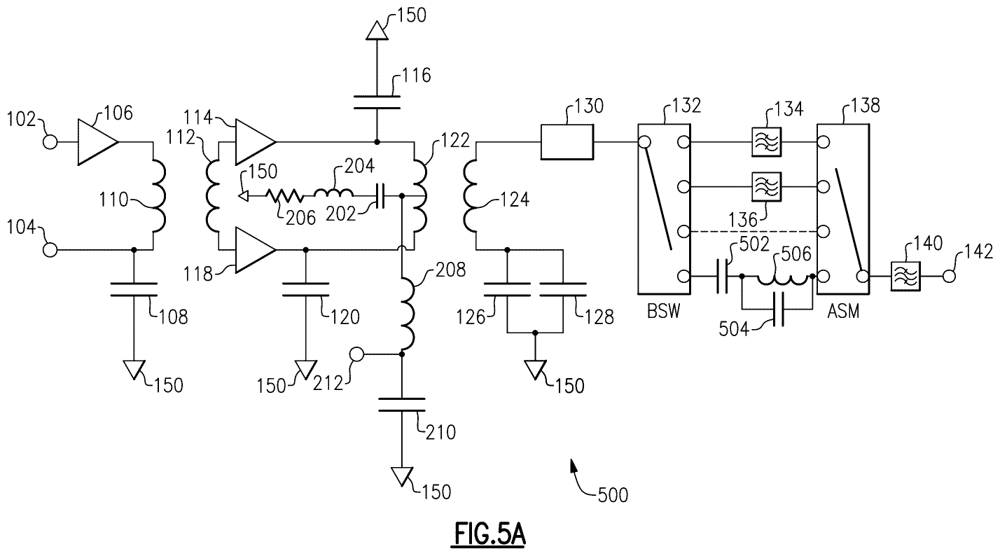

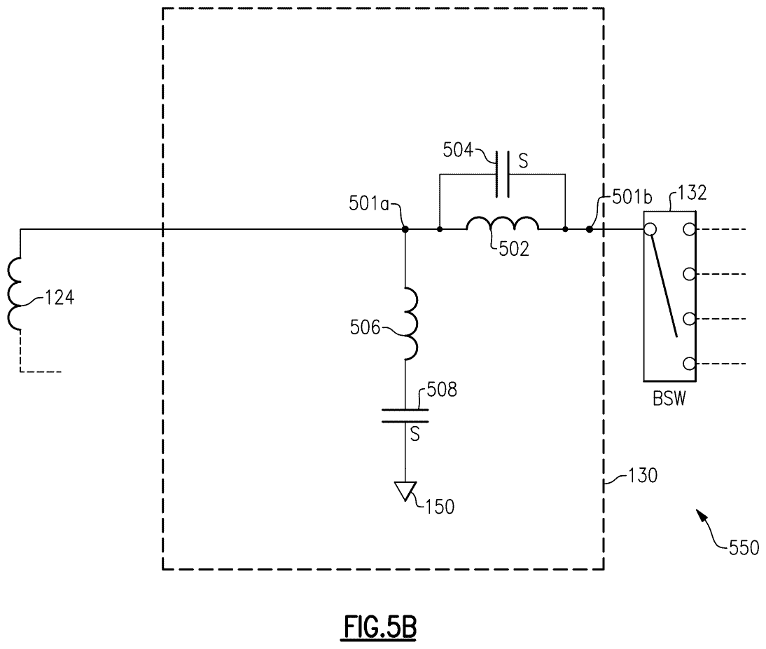

FIG. 3 illustrates a third topology 300 of an FEA according to an example. The third topology 300 is identical to the second topology 200, except as described below. The third topology 300 may incorporate the subsection 250 of FIG. 2B (that is, may have a filter section 130 identical to the filter section 130 of FIG. 2B) or subsection 550 of FIG. 5B (that is, may have a filter section 130 identical to the filter section 130 of FIG. 5B).

The third topology 300 differs from the second topology 200 in that the third topology 300 omits the fourth and fifth capacitors 126, 128, and couples the second end of the fourth winding 124 directly to the reference node 150.

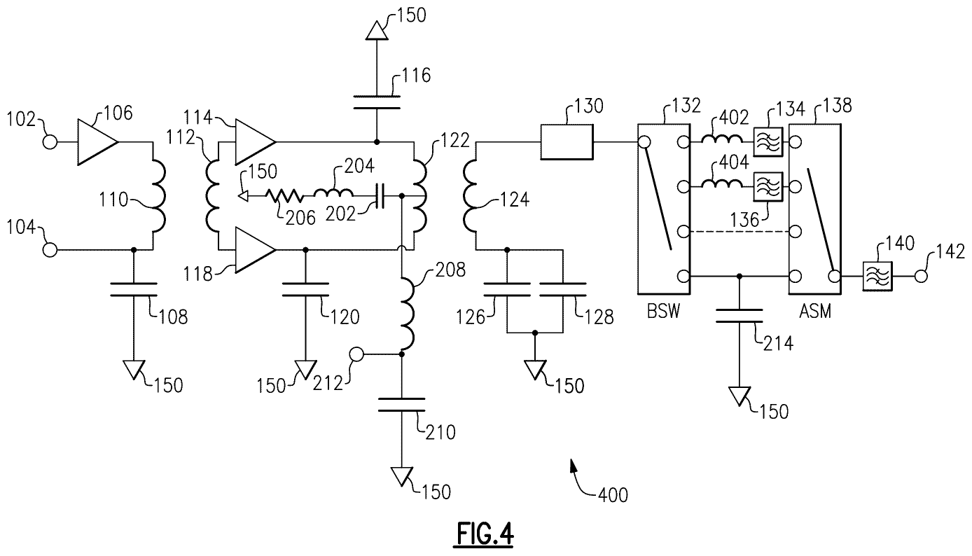

FIG. 4 illustrates a fourth topology 400 of an FEA according to an example. The fourth topology 400 is identical to the second topology 200, except as described below. The fourth topology 400 may incorporate the subsection 250 of FIG. 2B (that is, may have a filter section 130 identical to the filter section 130 of FIG. 2B) or subsection 550 of FIG. 5B (that is, may have a filter section 130 identical to the filter section 130 of FIG. 5B).

The fourth topology 400 adds a first inductor 402 and/or a second inductor 404. More generally, the fourth topology 400 may add inductors to any, some, and/or all of the conducting paths between the output terminals of the band switch 132 and the input terminals of the ASM 138. In some examples, the first inductor 402 is coupled between a first output of the band switch 132 and the first filter 134. In some examples, the second inductor 404 is coupled between a second output of the band switch 132 and the second filter 136. The inductors 402, 404 may provide better inductance matching to align the load lines (e.g., the conducting paths between the band switch 132 and ASM 138) better.

FIG. 5A illustrates a fifth topology 500 of an FEA according to an example. The fifth topology 500 is identical to the second topology 200, except as described below. The fifth topology 500 may incorporate the subsection 250 of FIG. 2B (that is, may have a filter section 130 identical to the filter section 130 of FIG. 2B) or subsection 550 of FIG. 5B (that is, may have a filter section 130 identical to the filter section 130 of FIG. 5B).

The fifth topology 500 omits the conducting path capacitor 214 that is coupled to the reference node 150. The fifth topology 500 adds a first conducting path capacitor 502, a second conducting path capacitor 504, and a conducting path inductor 506. The conducting path capacitors 502, 504 and the conducting path inductor 506 are coupled between an output terminal of the band switch 132 (e.g., the n^{th} output terminal), and an input terminal of the ASM 138 (e.g., the n^{th} input terminal). The first conducting path capacitor 502 is coupled at a first end to the output terminal of the band switch 132, and at a second end to respective first ends of the second conducting path capacitor 504 and conducting path inductor 506, such that the second conducting path capacitor 504 and the conducting path inductor 506 are in parallel. Respective second ends of the second conducting path capacitor 504 and conducting path inductor 506 are coupled to the input terminal of the ASM 138.

FIG. 5B illustrates a subsection 550 of the fifth topology 500 including the filter section 130, according to an example. The version of the filter section 130 shown in the subsection 550 may be appropriate for use in the fifth topology 500 or in any other topology disclosed herein.

The filter section 130 includes a first node 501a, a second node 501b, a first inductor 502, a first switchable capacitor 504, a second inductor 506, and a second switchable capacitor 508. Also shown are the fourth winding 124 and the band switch 132 to contextualize the connections of the filter section 130 to the fifth topology 500 and/or other topologies herein.

The first node 501a is coupled to the first end of the fourth winding 124 and to respective first ends of the first inductor 502, first switchable capacitor 504, and second inductor 506. The second node 501b is coupled to the input terminal of the band switch 132 and to respective second ends of the first inductor 502 and first switchable capacitor 504. The second inductor 506 is further coupled, at a second end, to the second switchable capacitor 508. The second switchable capacitor 508 is coupled to the reference node 150.

The first and second switchable capacitors 504, 508 may be switchable between both on and off (e.g., closed and open) states. When on, the switchable capacitors 504, 508 may be part of conductive paths (e.g., instead of being floating), while when off the switchable capacitors 504, 508 may be disconnected from the conductive paths (e.g., floating). For example, when the first switchable capacitor 504 is on, it may be coupled to both the first node 501a and second node 501b. When the first switchable capacitor 504 is off, it may be decoupled from one or both of the first node 501a and/or second node 501b. For example, when the second switchable capacitor 508 is on, it may be coupled to both the second inductor 506 and reference node 150. When the second switchable capacitor 508 is off, is may be decoupled from one or both of the second inductor 506 and/or reference node 150. In some examples, one or both of the switchable capacitors 504, 508 may have multiple states (e.g., multiple possible capacitances and/or configurable capacitances).

With respect to a combination of FIGS. 5A and 5B (e.g., where the fifth topology 500 includes the filter section 130 of FIG. 5B), the fifth topology 500 may be used to transmit signals using both 5G and 2G standards. In such cases, the switchable elements of the fifth topology 500 (e.g., switchable capacitors) may be set to on or off depending on whether the fifth topology 500 is transmitting using 5G or 2G. In some examples, the first switchable capacitor 504 may be on when the fifth topology 500 is transmitting using 5G and/or 2G, and/or may be off when transmitting using 5G and/or 2G. The second switchable capacitor 508 may be on and/or off when transmitting using 5G, and/or on and/or off when transmitting using 2G.

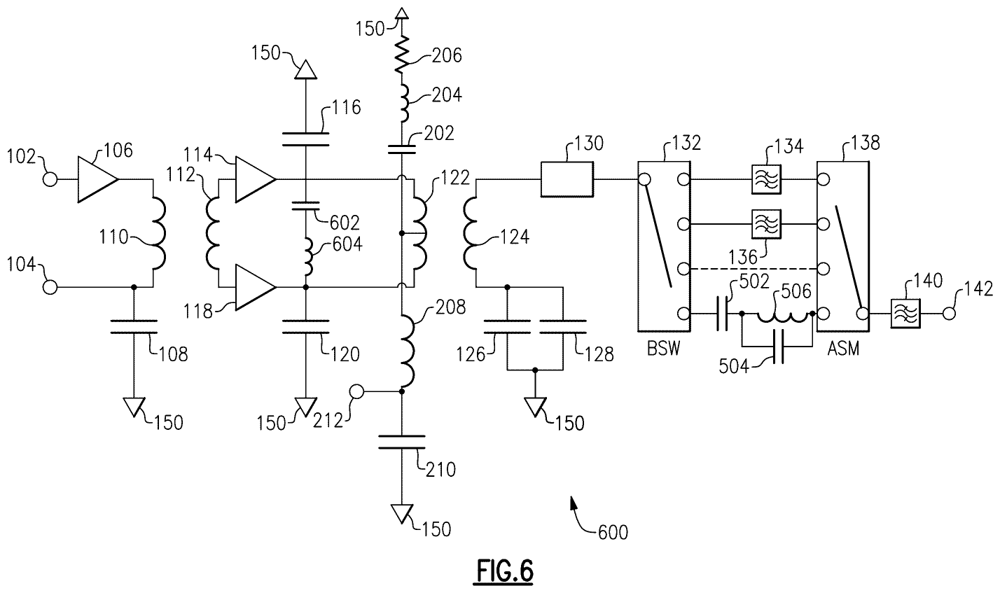

FIG. 6 illustrates a sixth topology 600 for an FEA according to an example. The sixth topology 600 may be identical to the fifth topology 500 except as described below. The sixth topology 600 may incorporate the subsection 250 of FIG. 2B (that is, may have a filter section 130 identical to the filter section 130 of FIG. 2B) or subsection 550 of FIG. 5B (that is, may have a filter section 130 identical to the filter section 130 of FIG. 5B).

The sixth topology 600 adds a first bridge capacitor 602 and a first bridge inductor 604 coupled in series between the output of the second amplifier 114 and the output of the third amplifier 118. A first end of the first bridge capacitor 602 is coupled to the output of the second amplifier 114. A second end of the first bridge capacitor 602 is coupled to a first end of the first bridge inductor 604. A second end of the first bridge inductor 604 is coupled to the output of the third amplifier 118.

In some examples, the first bridge capacitor 602 and first bridge inductor 604 may tune the harmonic impedance of the sixth topology 600.

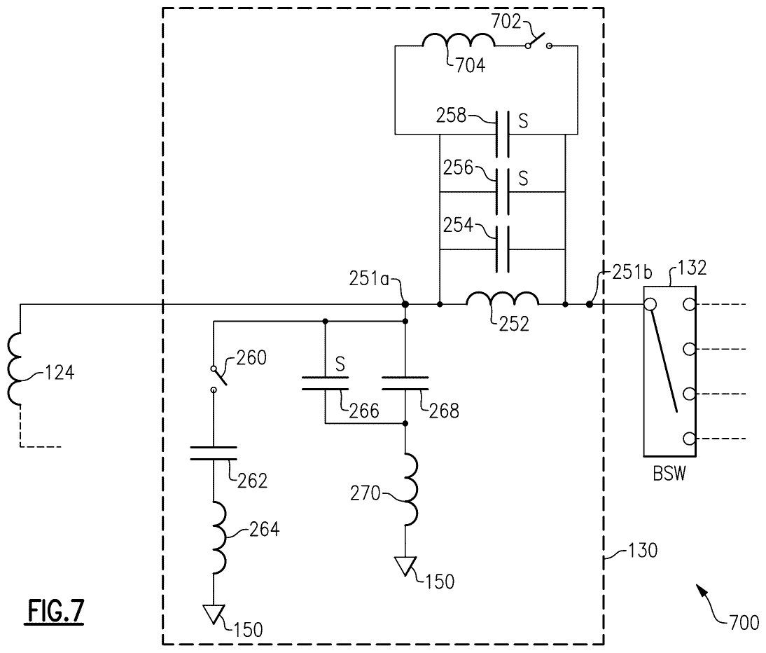

FIG. 7 illustrates a subsection 700 of the second topology 200 including the filter section 130, according to an example. The subsection 700 is identical to the subsection 250 of FIG. 2B except as provided. The subsection 700 adds a series switch 702 and a series inductor 704 connected in series with one another between the first node 251a and the second node 251b.

The series switch 702 is coupled at a first end to the second node 251b and at a second end to the series inductor 704. The series inductor 704 is coupled at a first end to the series switch 702 and at a second end to the first node 251a. The series switch 702 and series inductor 704 may improve coverage of harmonics and achieve more bandwidth for the load lines (e.g., the conducting paths between the band switch 132 and the ASM 138).

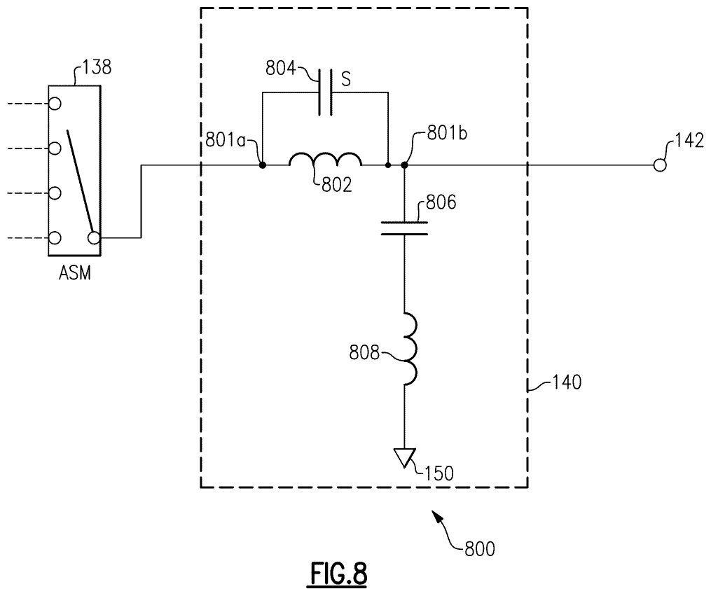

FIG. 8 illustrates a subsection 800 according to an example, the subsection 800 including an example of the ASM filter 140. The ASM 138 and output 142 are shown to contextualize the coupling of the ASM filter 140 as illustrated in FIG. 6.

The ASM filter 140 includes a first node 801a, a second node 801b, a first inductor 802, a switchable capacitor 804, a capacitor 806, and a second inductor 808. Respective first ends of the switchable capacitor 804 and first inductor 802 are coupled to the first node 801a. Respective second ends of the switchable capacitor 804 and first inductor 802 are coupled to the second node 801b. A first end of the capacitor 806 is coupled to the second node 801b, and a second end of the capacitor 806 is coupled to the second inductor 808. The second inductor 808 is further coupled to the reference node 150. The first node 801a is coupled to the output of the ASM 138. The second node 801b is coupled to the output 142.

The switchable capacitor 804 may be configured to be on or off. For example, when on, the switchable capacitor 804 may be coupled to both the first and second nodes 801a, 801b. When off, the switchable capacitor may be decoupled from the first and/or second nodes 801a, 801b. The switchable capacitor 804 may have multiple states providing multiple values of effective capacitance.

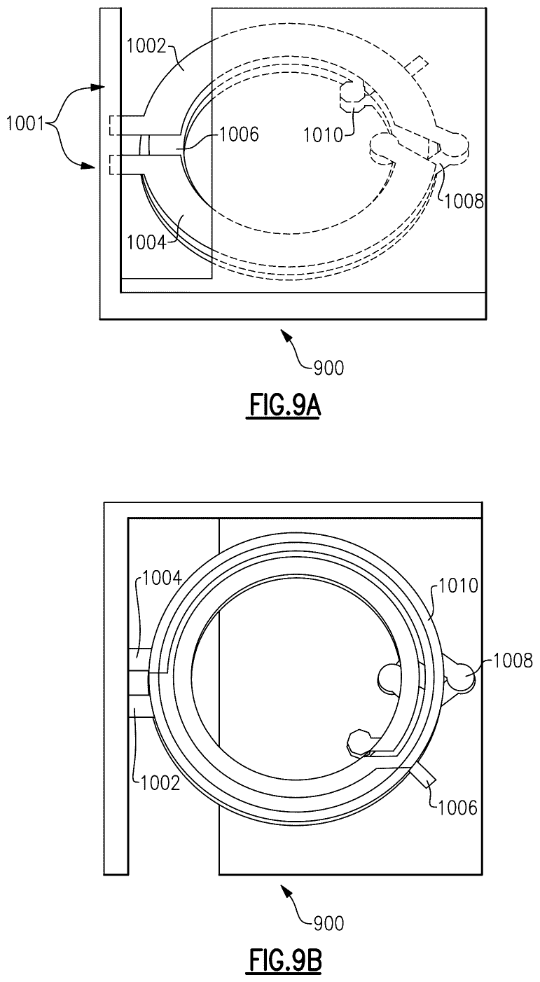

FIGS. 9A and 9B illustrates a balun 900 according to an example. FIG. 9A illustrates the balun 900 from a first perspective (“top-down”) according to an example, and FIG. 9B illustrates the balun 900 from a second perspective (“bottom-up”) according to an example.

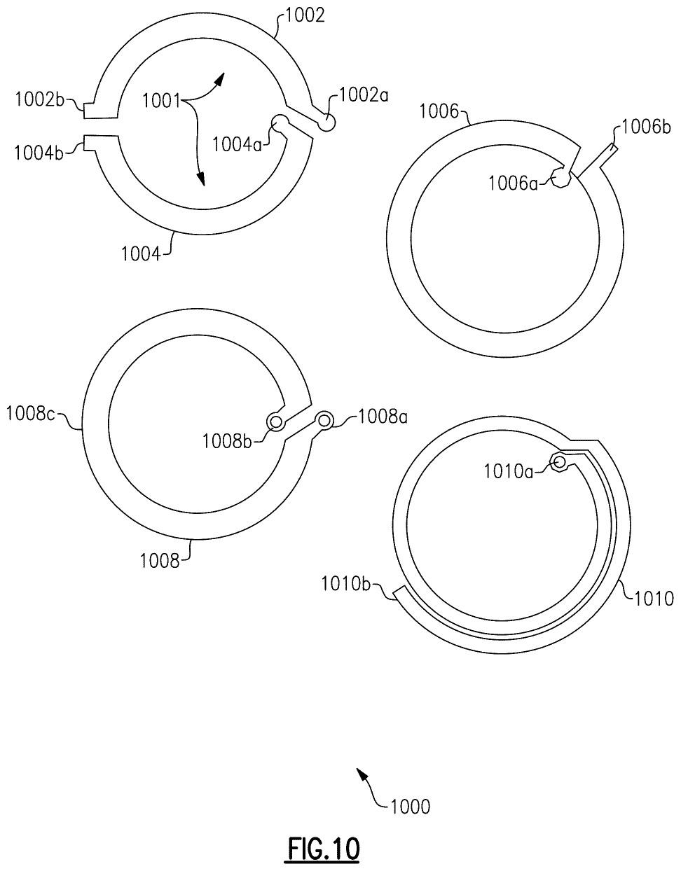

The balun 900 includes four layers, including a first section 1002 of the first layer 1001, a second section 1004 of the first layer 1001, a second layer 1006, a third layer 1008, and a fourth layer 1010. The first layer 1001 is coupled to the third layer 1008 via two connection points, with one connection point connecting the third layer 1008 to the first section 1002, and the other connection point connecting the third layer 1008 to the second section 1004. The second layer 1006 is coupled to the fourth layer 1010. The layers may also be tapped, that is, have connections to circuit elements not shown, such as via a center tap. The taps are discussed in more detail with respect to FIG. 10.

FIG. 10 illustrates an exploded view 1000 of the balun 900 of FIGS. 9A and 9B according to an example. The exploded view 1000 includes the first layer 1001 (including both the first and second sections 1002, 1004), the second layer 1006, the third layer 1008, and the fourth layer 1010. The first layer further includes a first connection 1002a, a second connection 1004a, a first input 1002b, and a second input 1004b. The second layer 1006 includes a third connection 1006a and a third input 1006b. The third layer 1008 includes fourth connection 1008a and a fifth connection 1008b, as well as a tap connection 1008c. The fourth layer 1010 includes a sixth connection 1010a and a fourth input 1010b.

The first connection 1002a is coupled to the fourth connection 1008a. The second connection 1004a is coupled to the fifth connection 1008b. The third connection 1006a is coupled to the sixth connection 1010a. The first input 1002b may be coupled to an external circuit element, and may be configured to receive a positive or negative voltage. The second input 1004b may be coupled to an external circuit element, and may be configured to receive a voltage of the opposite polarity of the first input 1002b. The third input 1006b may be configured to connect to an external circuit element and provide (or receive) a voltage. The fourth input 1010b may be configured to be coupled to an external circuit element and provide (or receive) a voltage.

In some examples, the first input 1002b may correspond to the first end of the third winding 122, and the second input 1004b may correspond to the second end of the third winding 122. The third input 1006b may correspond to the first end of the fourth winding 124, and the fourth input 1010b may correspond to the second end of the fourth winding 124. The tap connection 1008c may correspond to a tap connection of the third winding 122, for example, where the third winding 122 coupled to the first tap capacitor 202, and first tap inductor 208 of FIG. 3.

In some examples, except where explicitly coupled to one another, the layers 1001, 1006, 1008, 1010 may be separated from one another (e.g., insulated from one another, separated by a dielectric, and so forth).

Thus, in some examples, the first layer 1001 and third layer 1008 form the first winding 122 and the second layer 1006 and fourth layer 1010 form the second winding 124.

The layers 1001, 1004, 1006, 1008 may be made of electrically conductive material, and may be coupled (as described above) using electrically conductive material. The layers 1001, 1004, 1006, 1008 may be stacked, that is, located in a column, on a single substrate or multiple substrates.

Although only four layers are shown, additional layers may be used (e.g., 8, 16, 32 layers, or any other number of layers desired, whether odd or even). In some examples, the four layers shown will constitute the four bottom layers of the column or stack. The layers 1001, 1004, 1006, 1008 may be, in some examples, one or more of elliptical, polygonal, or piecewise segmented windings.

In some examples, the tap connection 1008c is located on an outer edge of the third layer 1006 (e.g., outer radius).

In some examples, the width (from inner radius to outer radius) of the layers 1001, 1006, 1008, 1010 may be approximately equal. In some examples, the inputs 1002b, 1004b, 1006b may protrude away from the edge of the circular or rounded portions of the layers 1001, 1006, 1008, 1010. In some examples, the first connection 1002a and/or fourth connection 1008a may protrude outward, while the second connection 1004a, third connection 1006a, fifth connection 1008b, and/or sixth connection 1010a may protrude inward (e.g., toward the center of the given layer). In some examples, the fourth connection 1010b may not protrude in either direction.

In some examples, the fourth layer 1010 may have a spiral shape. For example, the fourth layer 1010 may have a semicircular outer spiral section that wraps approximately halfway around a circular inner spiral section. These sections may have a width of half or less of the width of the other layers and/or the fourth layer 1010 as a whole.

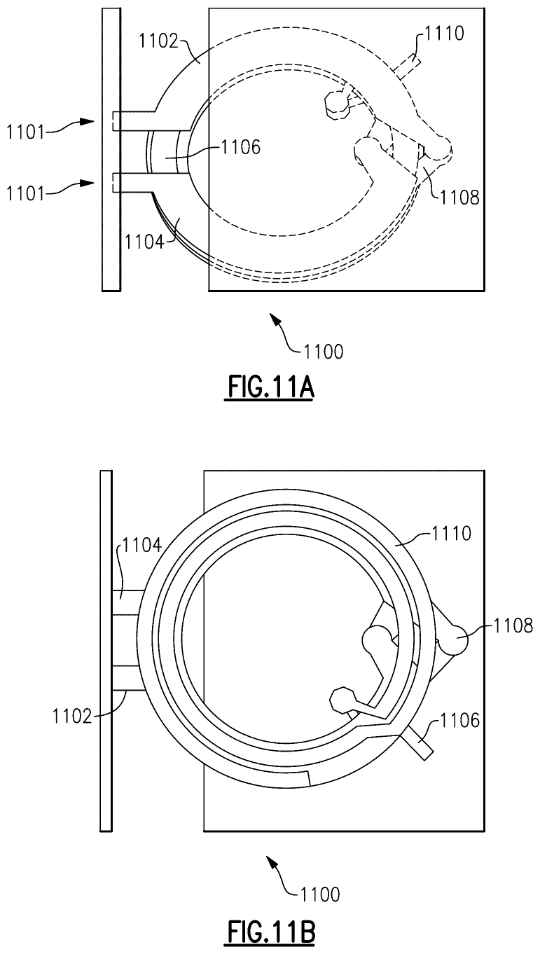

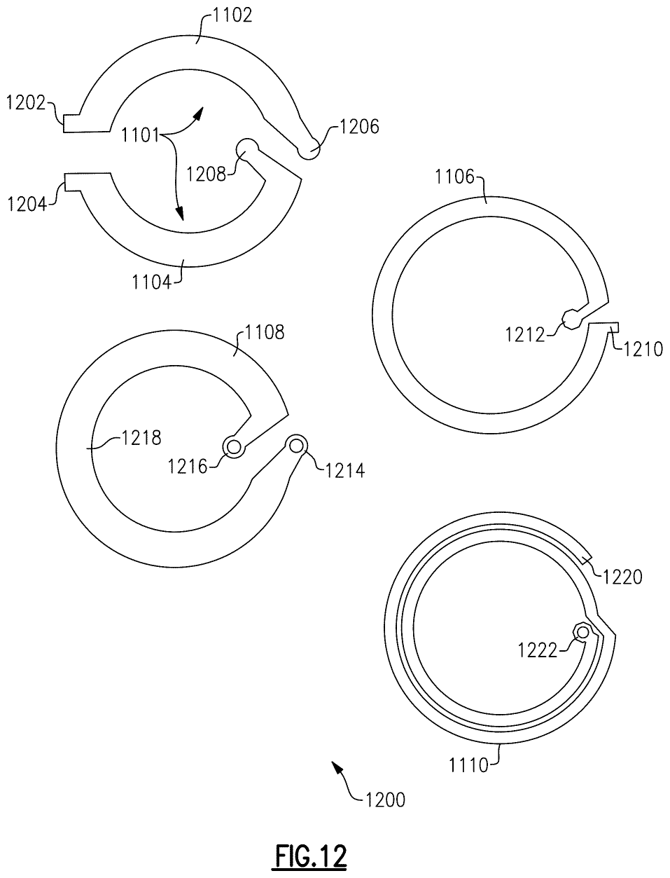

FIGS. 11A and 11B illustrates a balun 1100 according to an example. FIG. 11A illustrates the balun 1100 from a first perspective (“top-down”) according to an example, and FIG. 11B illustrates the balun 1100 from a second perspective (“bottom-up”) according to an example.

The balun 1100 includes a first layer 1101 having a first section 1102 and second section 1104, a second layer 1106, a third layer 1108, and a fourth layer 1110. These layers will be described in greater detail below.

The balun 1100 includes four layers, including a first section 1102 of the first layer 1101, a second section 1104 of the first layer 1101, a second layer 1106, a third layer 1108, and a fourth layer 1110. The first layer 1101 is coupled to the third layer 1108 via two connection points, with one connection point connecting the third layer 1108 to the first section 1102, and the other connection point connecting the third layer 1108 to the second section 1104. The second layer 1106 is coupled to the fourth layer 1110. The layers may also be tapped, that is, have connections to circuit elements not shown, such as via a center tap. The taps will be discussed in more detail with respect to FIG. 12.

FIG. 12 illustrates an exploded view of the balun 1100 according to an example. The first section 1102 includes a first input 1202 and a first connection 1206. The second section 1104 includes a second input 1204 and a second connection 1208. The second layer 1106 includes a third input 1210 and a third connection 1212. The fourth layer 1108 includes a third connection 1214, a fourth connection 1216, and a tap connection 1218. The fourth layer 1110 includes a fourth input 1220 and a sixth connection 1222.

The first input 1202 may be coupled to an external circuit element and/or configured to receive and/or provide a voltage. In some examples, the first input 1202 may correspond to the first end of the first winding 122. The second input 1204 may be coupled to an external circuit element and/or configured to receive or provide and/or receive a voltage. In some examples, the second input 1204 may correspond to the second end of the first winding 122. The third input 1210 may be coupled to an external circuit element and/or configured to provide and/or receive a voltage. In some examples, the third input 1210 may correspond to the first end of the fourth winding 124. The fourth input 1220 may be coupled to an external circuit element and/or configured to provide and/or receive a voltage. In some examples, the fourth input 1220 may correspond to the second end of the fourth winding 124.

The first connection 1206 may be coupled to the fourth connection 1214. The second connection 1208 may be coupled to the fifth connection 1216. The third connection 1212 may be coupled to the fifth connection 1222. The connections between the layers as described here may be using an electrically conductive material. The layers may be separated from one another by insulators, such as dielectrics or other substrates or materials.

With respect to the center of the layers 1101, 1106, 1108, 1110 (e.g., when stacked and/or coupled together), the first input 1202, second input 1204, and third input 1210 may protrude away from the center. The first connection 1206 and fourth connection 1214 may protrude away from the center. The second connection 1208, third connection 1212, and fifth connection may protrude toward the center. The fourth connection 1220 may not protrude in either direction.

In some examples, the second layer 1106 may be thinner than the first or third layers 1101, 1108. In some examples, the fourth layer 1220 may have a spiral shape, beginning at the fifth connection 1222 and ending at the fourth input 1220. In some examples, the spiral portions of the fourth layer 1110 may be half or less than half the width of the first layer 1101 and/or third layer 1108 (from inner radius to outer radius). In some examples, the fourth layer 1110 may have an inner circular region and an outer circular region (connected to the inner circular region). In some examples, the outer circular region may not fully surround the inner circular region.

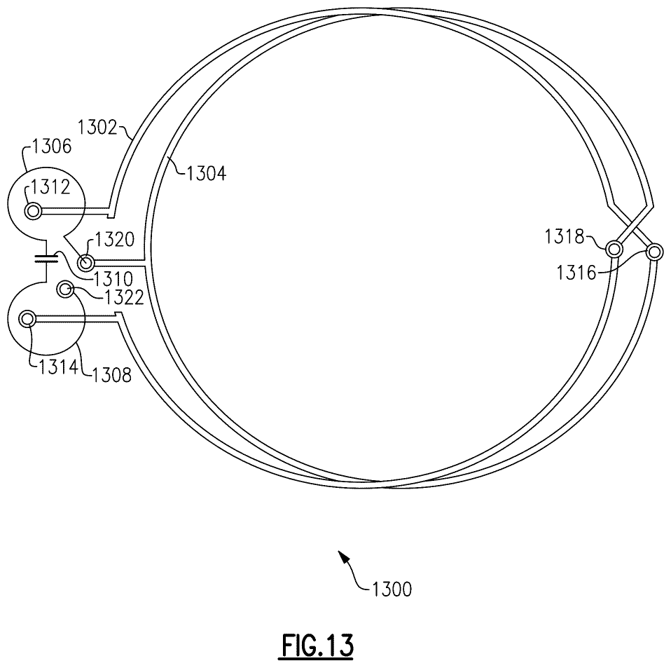

FIG. 13 illustrates an abstract diagram 1300 of a primary winding of a balun, such as the primary winding of the baluns of FIGS. 9-12, according to an example. In some examples, the diagram 1300 represents the third winding 122 and associated circuit elements.

The diagram 1300 includes a first section 1302 of the primary winding and a second section 1304 of the primary winding, as well as a first external winding section 1306 and a second external winding section 1308, and a capacitor 1310. The diagram 1300 also includes a first connection 1312, a second connection 1314, a third connection 1316, a fourth connection 1318, a fifth connection 1320, and a sixth connection 1322.

The first section 1302 may correspond to the first layers 1001, 1101 of FIGS. 9-12. The second section 1304 may correspond to the third layers 1008, 1108 of FIGS. 9-12. The external winding sections 1306, 1308 may correspond to the first tap inductor 204 of FIG. 2A, and the capacitor 1310 may correspond to the first tap capacitor 202 in some examples.

The first connection 1312 of the first section 1302 may correspond to the first input 1202, and the second connection 1314 of the first section 1302 may correspond to the second input 1204. The first and second connections 1312, 1314 may be coupled to other elements of a circuit, such as the second topology 200 of FIG. 2A.

First ends of the first section 1302 and second section 1304 are coupled at the third connection 1316, and second ends of the first section 1302 and second section 1304 are coupled together at the fourth connection 1318. The fourth connection 1318 may correspond to, for example, the second connection 1208 and the fourth connection 1216. The third connection 1316 may correspond to, for example, the first connection 1206 and the third connection 1214.

The second section 1304 is coupled to a first end of the first external winding section 1306 at the fifth connection 1320 (the fifth connection 1320 may correspond to the tap connection 1218). A second end of the first external winding section 1306 is coupled to a first end of the capacitor 1310. A second end of the capacitor 1310 is coupled to a first end of the second external winding section 1308. The sixth connection 1322 may be coupled to other circuit elements, such as other elements of the second topology 200, such as the first tap resistor 206.

With respect to FIG. 2A and the second topology 200, in some examples the tap inductor 204 may electromagnetically couple to the balun (e.g., to the third winding 122 and/or fourth winding 124). That is, in some examples, the third winding 122 may induce current on the tap inductor 204, or the tap inductor 204 may induce current on the third winding 122. This electromagnetic coupling may affect the balance of the balun (e.g., the third and fourth windings 122, 124). To account for this coupling, and to reduce the impact of the coupling of the tap inductor 204 on the third winding 122 and/or fourth winding 124, the tap inductor 204 may be coupled to the first winding 122 and/or the first tap capacitor 202 in two parts (corresponding to the external winding sections 1306, 1308. The external winding sections 1306, 1308 may be coupled with either odd or even symmetry relative to the third winding 122 to cancel out the effects of the inductive coupling (e.g., the electromagnetic coupling) between the tap inductor 204 and the balun (e.g., the third and/or fourth windings 122, 124).

In FIG. 13, the first external winding section 1306 and second external winding section 1308 are coupled in a symmetric manner (e.g., an even symmetric manner) to the tap connection (the fifth connection 1320) of the second section 1304 of the primary winding. In FIG. 13, the first external winding section 1306 is coupled to the fifth connection 1320, and is routed counterclockwise in a circular manner around the first connection 1312, and coupled to the first end of the capacitor 1310. Then, the second external winding section 1308 is then routed counterclockwise in a circular manner from the second end of the capacitor 1310 around the second connection 1314 to the sixth connection 1322.

Note that, while one circular route is shown for each external winding section 1306, 1308, there may be multiple turns on each winding.

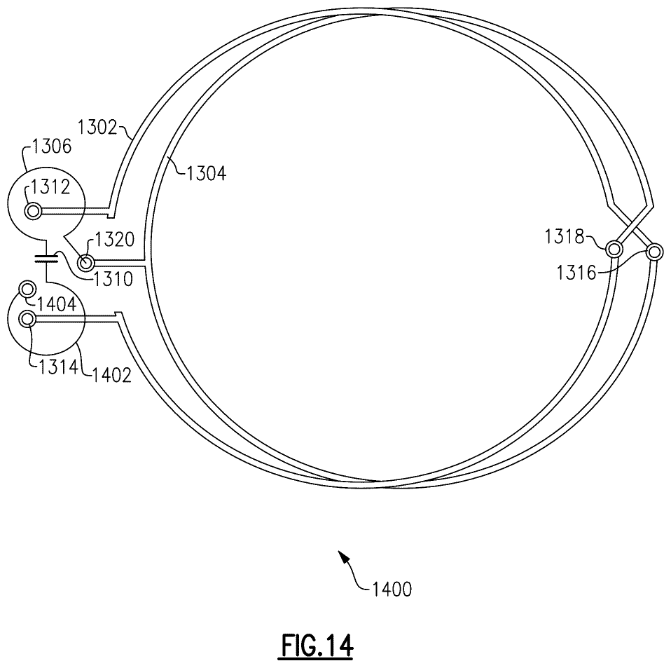

FIG. 14 illustrates an abstract diagram 1400 of a primary winding of a balun, such as the primary winding of the baluns of FIGS. 9-12, according to an example. The diagram 1400 is identical to the diagram 1300 of FIG. 13 with the following exceptions. The diagram 1400 includes a second external winding section 1402 that replaces the second external winding 1308 of FIG. 13, and a sixth connection 1404 that replaces the sixth connection 1322 of FIG. 13.

A first end of the second external winding 1402 is coupled to the second end of the capacitor 1310, and a second end of the second external winding 1402 is coupled to the sixth connection 1404. The sixth connection 1404 may be connected to other elements of the circuit (for example, other elements of the second topology 200, such as the first tap resistor 206).

The second external winding section 1402 is coupled in an odd symmetry relative to the first external winding section 1306 (as opposed to the even symmetry of the external winding sections 1306, 1308 in FIG. 13). In particular, the second external winding section 1402 is routed from the second end of the capacitor 1310 in a clockwise circular manner around the second connection 1314 to the sixth connection 1404.

Examples of the methods and systems discussed herein are not limited in application to the details of construction and the arrangement of components set forth in the description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as a microprocessor, processor, ASIC, FPGA, or similar device, may execute various operations discussed above. Using data stored in associated memory and/or storage, the controller also executes one or more instructions stored on one or more non-transitory computer-readable media, which the controller may include and/or be coupled to, that may result in manipulated data. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A front end module configured to provide first and second signals conforming to different standards in similar frequency bands, comprising:
a first input;
a second input;
a first balun coupled to the first input and the second input;
a second balun coupled to the first balun and configured to convert a double ended signal into a single ended signal;
a filter section coupled to the second balun and configured to selectively filter one or more components of the single ended signal; and
an output coupled to the filter section and configured to receive the single ended signal.

2. The front end module of claim 1 wherein the filter section includes a first node coupled to the second balun, and a second node coupled to the output, and further includes a parallel combination of a first switchable capacitor and a first inductor coupled between the first node and the second node, wherein the first switchable capacitor is configured to selectively couple or decouple from at least one of the first node or second node based on whether the front end module is providing a first type or a second type of signal.

3. The front end module of claim 2 wherein the filter section further includes a low impedance switch coupled between the first node and a reference node, and a second switchable capacitor coupled between the first node and the reference node, wherein the low impedance switch is configured to selectively be open or closed based on whether the front end module is providing the first type of the second type of signal, and the second switchable capacitor is configured to selectively be coupled to the first node based on whether the front end module is providing the first type of the second type of signal.

4. The front end module of claim 3 wherein the filter section further includes a series combination of a capacitor and an inductor coupled between the low impedance switch and the reference node.

5. The front end module of claim 3 wherein the filter section further includes a second inductor coupled between the second switchable capacitor and the reference node, and a capacitor coupled in parallel with the second switchable capacitor between the first node and the second inductor.

6. The front end module of claim 2 wherein the parallel combination further includes second switchable capacitor.

7. The front end module of claim 2 wherein the parallel combination further includes a second inductor.

8. The front end module of claim 2 wherein the filter section further includes a series combination of a second inductor and a second switchable capacitor coupled between the first node and a reference node, wherein the second switchable capacitor is configured to selectively couple or decouple to the reference node based on whether the front end module is providing the first type of the second type of signal.

9. The front end module of claim 2 wherein the filter section further includes a switch and an inductor coupled in series between the first node and the second node.

10. The front end module of claim 1 further comprising a first amplifier coupled between the first input and a first winding of the first balun and configured to provide an output signal to the first balun; and a capacitor coupled between the second input and a reference node.

11. The front end module of claim 1 further comprising a first amplifier coupled to a first end of a second winding of the first balun and configured to provide a first output signal to a first end of a first winding of the second balun; a second amplifier coupled to a second end of the second winding of the first balun and configured to provide a second output signal to a second end of the first winding of the second balun.

12. The front end module of claim 11 further comprising a first capacitor coupled between the first end of the first winding of the second balun and a reference node; and a second capacitor coupled between the second end of the first winding of the second balun and the reference node.

13. The front end module of claim 11 further comprising a series combination of an inductor and a capacitor coupled between an output of the first amplifier and an output of the second amplifier.

14. The front end module of claim 1 wherein the second balun includes a first winding and a second winding, the first winding having a tap located between a first end of the first winding and a second end of the first winding.

15. The front end module of claim 14 further comprising a first capacitor coupled to the tap and to a first inductor; a resistor coupled to the first inductor and a reference node; a second inductor coupled to the tap; a second capacitor coupled to the second inductor and to a reference node; and a voltage node coupled between the second capacitor and the second inductor and configured to provide a voltage.

16. The front end module of claim 14 further comprising one or more capacitors coupled between a second end of the second winding and a reference node, wherein the filter section is coupled to a first end of the second winding.

17. The front end module of claim 1 further comprising a first switch coupled to the filter section; and a second switch coupled to the first switch and to the output, wherein the first switch has one input and a plurality of outputs, and the second switch has one output and a plurality of inputs, wherein each output of the plurality of outputs is coupled via respective path to a respective input of the plurality of inputs.

18. The front end module of claim 17 further comprising an output filter coupled between the second switch and the output, wherein the output filter includes a first node coupled to the output of the second switch, and a second node coupled to the output, a parallel combination of a switchable capacitor and an inductor coupled between the first node and the second node, the switchable capacitor being configured to selectively couple or decouple from one of the first node or second node based on whether the front end module is providing a first type or a second type of signal.

19. The front end module of claim 18 wherein the output filter further includes a series combination of a capacitor and an inductor coupled between the second node and a reference node.

20. The front end module of claim 1 wherein
the second balun includes four or more layers, including a first layer, a second layer, a third layer, and a fourth layer, wherein the first layer is coupled to the third layer via a first connection and a second connection, and the second layer is coupled to the fourth layer via a third connection, wherein a tap of the second balun is coupled to the third layer;
the first layer of the second balun includes a first section and a second section, the first section having a first input and the first connection, and the second section having a second input and the second connection; and an inductor is coupled to the tap and routed around the first input and the second input with at least one of odd symmetry or even symmetry.
